(19) United States
(12) Patent Application Publication
(10) Pub. No.: US 2014/0306168 A1
(43) Pub. Date: Oct. 16, 2014

(54) PHOTOSENSITIZATION OF PERSULFATE FOR PHOTO-INDUCED POLYMERIZATION

(71) Applicants: Douglas C. Neckers, Perrysburg, OH (US); Puran K. De, Bowling Green, OH (US); Oleg Grinevich, Holland, OH (US); Alex Mejiritski, Bowling Green, OH (US)

(72) Inventors: Douglas C. Neckers, Perrysburg, OH (US); Puran K. De, Bowling Green, OH (US); Oleg Grinevich, Holland, OH (US); Alex Mejiritski, Bowling Green, OH (US)

(73) Assignee: SPECTRA GROUP LIMITED, INC., Millbury, OH (US)

(21) Appl. No.: 13/861,517

(22) Filed: Apr. 12, 2013

(51) Int. Cl. C08G 63/87

(52) U.S. Cl. CPC C08G 63/87
USPC 252/600

(57) ABSTRACT

The present invention relates to compositions and processes for photoinitiating polymerization. Process for photoinitiating polymerization with ‘persulfate anion’ via photosensitized decomposition of persulfate anion with a composition that includes a light absorber, an electron transfer donor or acceptor, and a persulfate are described.

### CROSS-REFERENCE TO RELATED APPLICATION

This application claims the benefit of U.S. application Ser. No. 13/447,866 filed Apr. 16, 2012 (a request is pending to have that application converted to a provisional application).

### BACKGROUND OF THE INVENTION

The thermal decomposition of potassium persulfate has been extensively studied in water. However, in contrast to the decomposition of diacyl peroxides in organic solvents, the decomposition of potassium persulfate is strictly first order, and has not been observed to be retarded by any inhibitor. These decompositions are temperature dependent. At 50° C. the first order rate constant for persulfate anion decomposition is 1×10⁻⁶ sec⁻¹ and the reaction has a measured activation energy of 35.5 kcal/mol. That suggests a half life of days at that temperature.

The decomposition of persulfate anion is catalyzed by the presence of suitable electron/proton donors such as amines. Persulfate anion—amine systems have been used at room temperature as one or two part initiators for the polymerization of various monomers. Persulfate anion, in presence of either an electron or a H-donor (such as methanol), undergoes rapid decomposition via the formation of the sulfate ion radical. The photodecomposition of persulfate anion, on the other hand, is slow, and it requires short wavelength (280 nm) light to achieve a marginally useful rate. Though free radical formation is usually observed, the wavelength required for the reactions is too short to be suitable for many applications.

The present inventors have discovered that the photodecomposition of persulfate anion is photosensitized using light and a dye to produce radicals from suitable donors thereby enabling the use of persulfate anion as an accelerator/initiator for a photopolymerization process.

### SUMMARY OF THE INVENTION

The present invention encompasses compositions and processes for photoinitiating polymerization.

The present invention encompasses compositions and processes for photoinitiating polymerization with persulfates via photosensitized decomposition of the persulfate anion

Certain embodiments of the present invention encompass compositions and processes for photoinitiating polymerization with persulfate anions via the photosensitized decomposition of persulfate anions with a system that includes a light absorber, an electron transfer donor or acceptor, a persulfate having the formula Xᵢ persulfate anion where X may be a metal cation (Na, K, Li, Cs, Ru, etc.), organic cations (e.g., NR₄⁺, PR₄⁺, SR₃⁺, OR₃⁺, IR₂⁺) or a dye cation, and i represents 1 when the valence of X is 2 and i represents 2 when the valence of X is 1. The term “light” as used herein encompasses visible and non-visible actinic radiation including but not limited to the specific radiation sources disclosed herein.

One embodiment of the present invention includes compositions comprising a persulfate anion and a dye and, more particularly, a salt of a cationic dye and a persulfate anion.

A further embodiment of the present invention includes a composition comprising a persulfate anion and the dye Methylene Blue as shown by the following formula (I).

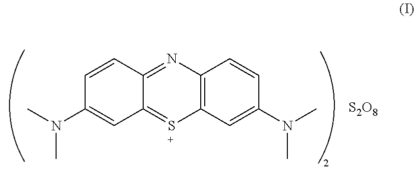

A still further embodiment of the present invention includes a composition comprising persulfate anion and a dye which may be a water soluble aromatic ketone.

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the scope of the present invention.

The photo-induced decomposition of persulfate anion is described herein. This decomposition results in polymerizations at room temperature using actinic radiation with persulfate anion as the initiator in water-based systems and emulsions. Systems in accordance with the present invention may include a light absorber, an electron transfer donor, Xᵢ persulfate where X may be a metal ion (e.g., Na, K, Li, Cs, Ru, etc.) that may be monovalent, divalent or trivalent) or an organic cation (e.g., NR₄⁺, PR₄⁺, SR₃⁺, OR₃⁺, IR₂⁺), or a dye cation, i is 1 or 2 depending on the valence of X; and R represents a straight, branched or cyclic alkyl group having 1 to 10 carbon atoms and more typically 1 to 6 carbon atoms, an aryl group having 6 to 20 carbon atoms such as a substituted or unsubstituted phenyl group, substituted or unsubstituted poly(cyclic) aromatic group such as naphthyl, anthracene, phenanthrene and the like each of which can bear substituents such as alkyl, aryl, halogen, amino, quaternary ammonium ions, phosphines, phosphonium ions, etc. Also R may be a heterocyclic group such as a thiophene moiety and its condensed cogeners benzothiophenes, naphthothiophenes, anthrothiophenes, also heteroaromatic groups such as furans, benzofurans, pyrroles, indoles. This reaction may proceed at room temperature or below in water-based systems and emulsions.

In one embodiment the light absorber is a cationic dye. Useful dyes form photoreducible but dark stable complexes with persulfate anions and can be cationic methine, polymethine, triarylmethane, indoline, thiazine, xanthene, oxazine and acridine dyes. More specifically, the dyes may be cationic cyanine, carbocyanine, hemicyanine, rhodamine and azomethine dyes. In addition to being cationic, in one embodiment, the dyes do not contain groups that would neutralize or desensitize the complex or render the complex poorly dark stable. Examples of groups that generally are not desirable in the dye are acid groups such as free carboxylic or sulfonic acid groups. Specific examples of useful cationic dyes are Methylene Blue, Safranine O, Malachite Green, cyanine dyes and rhodamine dyes.

Electron donors useful in the present invention include anionic borates R¹R²R³R⁴B⁻, where R¹, R², R³, and R⁴ may be the same or different and may be alkyl or aryl (e.g., substituted or unsubstituted C1-C10 alkyl or C6-C20 aryl), anionic tetraaryl borates R¹-R⁴=aryl (e.g., substituted or unsubstituted C6-C20 aryl and particularly substituted or unsubstituted phenyl). An onium salt having an anion of the formula GₐXₐR⁵_{b} where X is a halogen atom or a hydroxy group, R⁵ is a substituted or unsubstituted C6-C20 aryl group, a and b represent integers of 0 to 4 and the sum of a and b is 4. in the manner of U.S. Pat. No. 6,166,233. The onium gallates include an anionic gallate moiety and a cationic moiety. The anionic gallate moiety has the formula in which X is a halogen or a hydroxy group, R⁵ is an aryl group, a and b represent integers ranging from 0 to 4 and the sum of a and b is 4. The cationic moiety is selected from the group consisting of iodonium, pyrylium, thiapyrylium, sulphonium, phosphonium, ferrocenium, and diazonium ions. The onium gallates are useful as cationic initiators of polymerization. Representative examples of electron donors include sodium tetraphenylborate, sodium tetraphenylgallate, primary/secondary/tertiary alkyl and aryl amines (e.g. triethanolamine (TEA), triethanolamine triacetate (TEATA), aromatic amines (e.g. aniline, diisopropyl dimethyl aniline (DIDMA), metaphenylenediamine (MPDA), diaminodiphenylmethane (DDM), benzyldimethylamine (BDMA), N-containing heterocyclic aliphatic compounds (pipyridine, triethylenediamine), N-containing heterocyclic aromatic compounds and their derivatives (e.g. pyridine, 4-dimethylamino pyridine (DMAP), aliphatic and cycloaliphatic amines (e.g. dicyclohexyl amine), cyclic diazo derivatives (e.g. diazobicyclooctane (DABCO), diazobenzononane (DBN)), aliphatic diamines (e.g. ethylenediamine, 1,3-diaminopropane, cycloaliphatic and aromatic diamines (e.g. isophoronediamine (IPDA), 3-cyclohexylaminopropylamine, aliphatic oligoamines (e.g. diethylenetriamines, dipropylenetriamine), polyetheramines (polyetheramine D400, T403 (available from BASF Corp.), imidazole and their derivatives (e.g. imicure AMI1 (available from Air Products; N-methylimidazole), Imicure AMI 2 (Air Products; 2-methylimidazole), Imicure EMI 24 (Air Products; 2-ethyl-4-methylimidazole), Curezol 1B2MZ (Air Products; 1-Benzyl-2-methylimidazole), Curezol 2PZ (Air Products, 2-phenylimidazole), Curezol 2P4MZ (Air Products; 2-phenyl-4-methylimidazole), Curezol 2MZ Azine (Air Products; 2,4-Diamino-6-(2-(2-methylimidazol-1-yl)ethyl)-1,3,5-triazine), and other amine containing compounds (e.g. Irgacure 369 (BASF Corp.; 2-(dimethylamino)-1-(4-morpholin-4-ylphenyl)-2-(phenylmethyl)butan-1-one)), phosphates, arsenates, antimonite, etc.

Electron Acceptors such as xanthene dyes, may also serve as either oxidizers or reducers (below) when illuminated in the presence of a reducing agent or oxidizing agent as shown below.

[Xanthene dye]^{m-}+Rₙ\ddot{X}+light→

[Xanthene dye]^{m2-}+Rₙ\dot{X}⁺

where RₙX generally represents an oxidizer that donate a electron to the excited dye. In one embodiment the oxidizer is an amine

Or

[Xanthene dye]^{m-}+Rₐ\dot{X}⁺+light→

[Xanthene dye]^{m--1}+Rₐ\ddot{X}⁺

where Rₐ generally represents a reducer that donates a hydrogen to the excited dye. In one embodiment the reducer is iodonium or sulfonium, for example m represents a non-zero integer.

In one embodiment any excited state of a diaryl ketone that abstracts a hydrogen atom from an alcohol is potentially useful. The critical reaction being the reaction of the persulfate ion with .CH₂OH to generate the sulfate radical in the manner of:

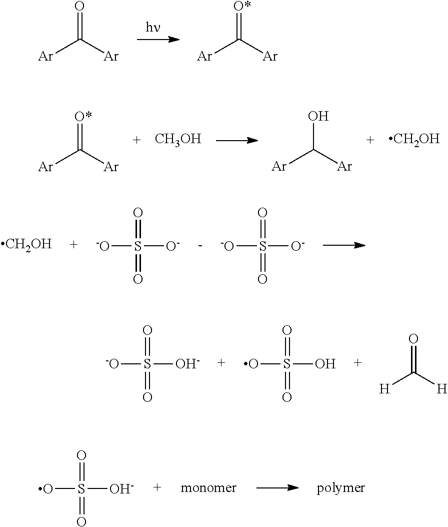

Excited state hydrogen atom abstractors such as aromatic ketones, aldehydes, ketone acetals and the like may be used with hydrogen atom donors such as primary (RCH₂OH) and secondary (R¹R²CHOH) alcohols including methanol (CH₃OH) may be used where R¹ and R² are the same or different and are defined as above.

In general, any aromatic, aromatic aliphatic or aliphatic ketone capable of abstracting a hydrogen atom from a hydrogen donor may be used, e.g., ArCOAr, ArCOR, RCOR.

Any aldehyde as long as the excited state abstracts hydrogen atoms:

RCHO+RCH₂OH→RĊ(OH)H+RĊHOH

And any of the general class of photo-initiators (Type II) that abstract hydrogen atoms (as above) or photoinitiators (Type I) some of which are commercially available from BASF under the trademark IRGACURE that decompose to form free radicals capable of abstracting hydrogen atoms:

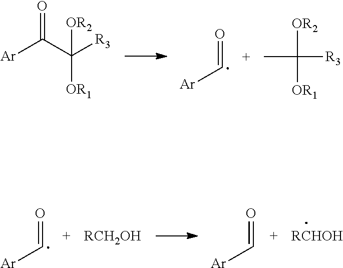

Overall:

Hydrogen Abstractor+light→

Reactive Hydrogen Abstractor (RAH)*

(RAH)*+R₂CHXH→R\dot{A}H-H+R₂ĊXH

where R may be the same or different and represent alkyl, aryl or H where X is a non-oxidizable to (RAH)* atom

The sulfate ion radical is generated from the photosensitized degradation of persulfate anion by a radical formed either from a photochemical electron transfer reaction involving a light absorber and an electron donor or from the radical formed from hydrogen atom donor. The latter is in the manner of the thermal reaction of potassium persulfate in methanol where the radical formed from the solvent .CH₂OH induces the decomposition of the persulfate anion by an electron transfer followed by the loss of a proton H⁺ (product formaldehyde) and sulfate anion radical (immediately trapped by H⁺) (JACS 71 1419 1949) save in the present case the radical inducing decomposition of the persulfate anion is formed from the dye subsequent to light absorption.

The photo decomposition reaction mechanism with an electron donor is shown below:

dye+light+electron donor→dye⁻.+donor⁺.

dye⁻.+persulfate 2−→SO₄2−+SO₄⁻.

donor⁺.→donor.+H⁺

donor.+persulfate²⁻→SO₄²⁻+SO₄^{-.}

SO₄⁻.+monomer→polymerization.

H⁺+SO₄²⁻→HSO₄^{→}

In the case of Methylene Blue, the excited state of which is an electron acceptor, the reaction is:

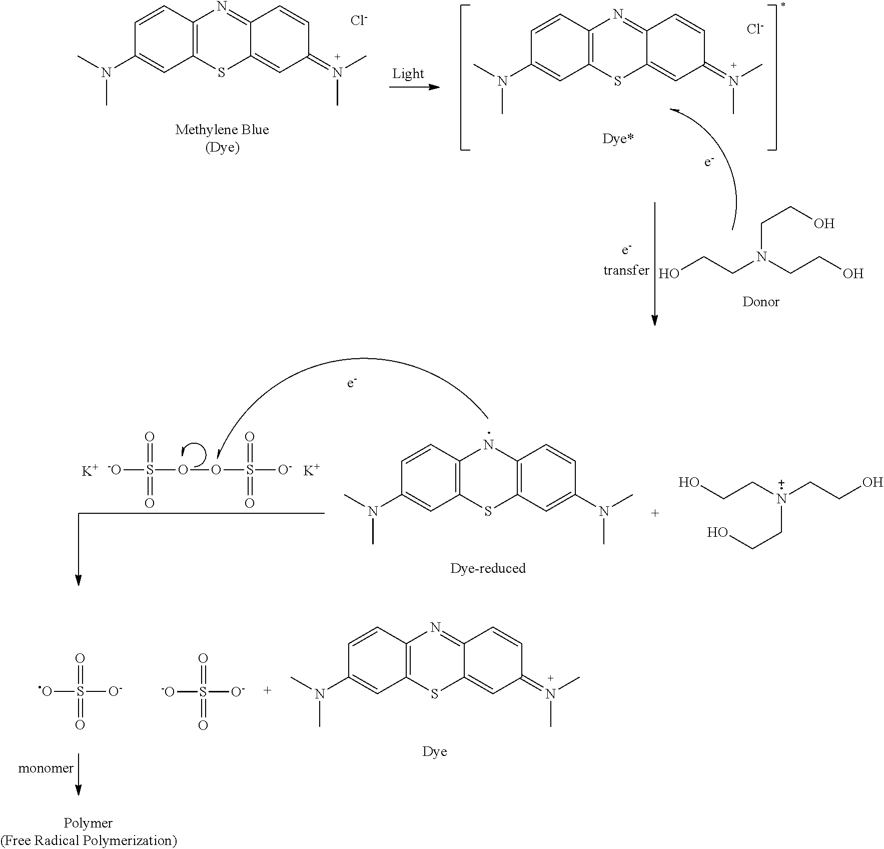

The reaction of the triethanolamine upon donating the electron is:

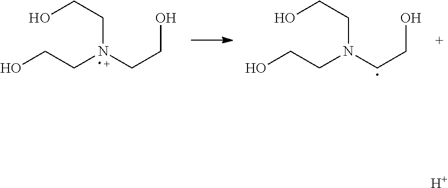

In one embodiment the sulfate radical is next used to accelerate/assist polymerization processes in water based monomer systems of which one is an acrylate. Typical reactions are shown in the equations below:

Light Absorber+Electron/H-donor+Persulfate+Acrylate→Photopolymerization

Light Absorber,persulfate+Electron/H Donor+Acrylate→Photopolymerization

The accelerating reaction mechanism proposed is caused by the radical formed from the light absorber and the donor. In an alcohol such as methanol that radical would be .CH₂OH; in an amine such as trimethylamine that radical would be .CH₂N(CH₃)₂; from tetraphenyl borate anion that radical would be .Ph.

In another case, the sulfate radical is generated from the photosensitized rapid degradation of persulfate anion by a radical formed from a photochemical electron transfer reaction involving a light absorber and an electron acceptor or a hydrogen donor. The sulfate radical thereby formed is next used to accelerate/assist polymerization processes in water based acrylate systems.

### EXAMPLES

Particular embodiments of the present inventions, the results of which are shown in Tables 1-4 with further detail provide in Examples 1-7:
(i) Polymerization of three water dispersible/miscible acrylic monomers in presence of 20% water: (a) SR 415 (ethoxylated triacrylate available from Sartomer, U.S.A.), (b) SR 553 (polyethylene glycol (PEG) methacrylate) Sartomer, U.S.A., and (c) SR 740A—a polyethylene glycol (PEG) dimethacrylate, Sartomer U.S.A. was studied.
(ii) The effect of the electron/H-donors was studied by comparing the rate of the polymerization of the monomers above in the presence of these various donors.
(iii) The polymerization of emulsions using water immiscible monomers: (a) SR 399 (trimethylolpropane triacrylate (TMPTA)) in presence of water and suitable surfactants.
(iv) Rate comparisons are made based on the threshold of the light-energy to start the polymerization. No quantitative rate measurements were performed.

Light Sources and Doses:
[1] Visible Light Projector with Kapton Film; 500-800 nm light; Intensity ˜1.05 WCm²
[2] Visible Light Projector; 400-800 nm light; Intensity ˜1.33 WCm²
[3] UV Promotorcar; Metal Halide Lamp, λₘₐₓ˜365 nm (Bandpass ˜320-420 nm); Intensity ˜11.33 mWCm

TABLE 1
Controls with Different Dyes.

| | Potassium | | | Thermal | Photo- | Light |
|---|---|---|---|---|---|---|
| Monomer | Persulfate | Dye | Donor | Reaction | reaction | Source |
| ETMPTA:Water | 1 Part | Methylene Blue- 1 Part | None | Stable | 500 Sec | [1] |
| (80:20)- | | WSCD- 1 Part | None | 2-3 Min | 15 Sec | [1] |
| 100 Parts | | Azure A- 1 Part | None | Stable | 900 Sec | [1] |
| | | Rose Bengal- 1 Part | None | Stable | 300 Sec | [2] |
| | | Eosin Y- 1 Part | None | Stable | 200 Sec | [2] |
| | None | Methylene Blue- 1 Part | TEA- 1 Part | Stable | 60 Sec | [1] |
| | | Methylene Blue- 1 Part | DIDMA- 1 | Stable | No | [1] |
| | | | Part | | | |
| | | Methylene Blue- 1 Part | Pyridine- 1 | Stable | No | [1] |
| | | | Part | | | |
| | | Methylene Blue- 1 Part | NaBPh₄- 1 | Stable | No | [1] |
| | | | Part | | | |

* ETMPTA-Ethoxylated (20) trimethylolpropane triacrylate; WSCD-water soluble cyanine dye, 2-[5-[3,3-dimethyl 1-(4-sulfobutyl)-1,3-dihydro-indol-2-ylidene]-penta-1,3-dienyl]-3,3-dimethyl-1-(4-sulfobutyl)-3H-indolium hydroxide, inner salt, sodium salt; TEA-triethanolamine; DIDMA-2,6-diisopropyl-N,N′-dimethylaniline.

TABLE 2
Dye-Donor-Persulfate System - Polymerization of Acrylic Monomers.
Light Source [1] was used for all the experiments reported in this table.
Thermal Reaction vs. Photoreaction - same conditions: Thermal

| | Potassium | Methylene | | Thermal | Photo- |
|---|---|---|---|---|---|
| Monomer | Persulfate | Blue | Donor | Reaction | reaction |
| ETMPTA:Water | 1 Part | 0.1 Parts | None | Stable | 500 Sec |
| (80:20)- | | | TEA- 1 Part | 3 Min 30 Sec | 1-2 Sec |
| 100 Parts | | | TEATA- 1 Part | 30 Min | 100 Sec |
| | | | DIDMA- 1 Part | 12 h | 12-15 Sec |
| | | | DMAP- 1 Part | 1 h 30 Min | 15 Sec |
| | | | Pyridine- 1 Part | Stable | 120 Sec |
| | | | NaBPh₄- 1 Part | Stable | 10-12 Sec |
| | | | KB(C₆F₅)₄- 1 Part | Stable | 330 Sec |
| | | | DBN- 1 Part | Stable | 90 Sec |
| | | | DABCO- 1 Part | Stable | No |
| | | | CGI 277- 1 Part | 24 h | 30 Sec |
| | | | CGI 90- 1 Part | Stable | 150 Sec |
| | | | Irgacure 369- 1 Part | 24 h | 40 Sec |
| | | | Imicure AMI 1- 1 Part | 6 h | 60 Sec |
| | | | Imicure AMI 2- 1 Part | Stable | 300 Sec |
| | | | Imicure EMI 24- 1 Part | Stable | No |
| | | | Curezol 2MZ Azine- 1 Part | Stable | 90 Sec |
| | | | Curezol 2B2MZ- 1 Part | Stable | 105 Sec |
| MPEGA:Water | 1 Part | 0.1 Part | NaBPh₄- 1 Part | Stable | 50 Sec |
| (80:20)- | | | DIDMA- 1 Part | Stable | 70 Sec |
| 100 Parts | | | None | Stable | No |
| | None | 0.1 Part | DIDMA- 1 Part | Stable | No |
| PEGDMA:Water | 1 Part | 0.1 Part | NaBPh₄- 1 Part | Stable | 70 Sec |
| (80:20)- | | | DIDMA- 1 Part | Stable | 450 Sec |
| 100 Parts | | | None | Stable | No |
| | None | 0.1 Part | DIDMA- 1 Part | Stable | No |

* ETMPTA-Ethoxylated (20) trimethylolpropane triacrylate; MPEGA-methoxy polyethyleneglycol (550) monoacrylate; PEGDMA-polyethyleneglycol (1000) dimethacrylate; TEA-triethanolamine; TEATA-triethanolamine triacetate; DIDMA-2,6-diisopropyl-N,N′-dimethylaniline; DMAP-4-(N,N′-dimethylamino)-pyridine; DBN-1,5-diazabicyclo[4.3.0]non-5-ene; DABCO-1,4-diazabicyclo[2.2.2]octane.

TABLE 3
Emulsion Polymerization.
Light Source [1] was used for all the experiments reported in this table.
Thermal Reaction vs. Photoreaction - same conditions: Thermal

| | | | Methylene | | Potassium | Thermal | Photo- |
|---|---|---|---|---|---|---|---|
| Monomer | Surfactant | Water | Blue | Donor | Persulfate | Reaction | reaction |
| TMPTA- | SPAN 20- | 30 Parts | 0.2 Parts | TEA- 1 Part | 1 Part | 5 Min | No |
| 100 Parts | 30 Parts | | | | | | |
| | None | 30 Parts | 0.2 Parts | NaBPh₄- 1 Part | 1 Part | Stable | 30 Sec |
| | SPAN 20- | 30 Parts | 0.2 Parts | NaBPh₄- 1 Part | 1 Part | Stable | 40 Sec |
| | 30 Parts | | | | | | |

* TMPTA-Trimethylolpropane triacrylate; SPAN 20-sorbitan monolaureate; TEA-triethanolamine.

TABLE 4
Methylene Blue Persulfate (MBPS) for Photopolymerization.
Light Source [1] is used for all the experiments reported in this table.
Thermal Reaction - Photoreaction - same conditions: Thermal - without light;
Photo - with light [1].

| | | | | Thermal | Photo- |
|---|---|---|---|---|---|
| Monomer | Light Absorber | Donor | DMAA | Reaction | reaction |
| TMPTA- 100 Parts | Methylene | NaBPh₄-1 Part | 10 Parts | Stable | No |
| | Blue- 0.1 Parts | | | | |
| | MBPS- 0.1 Parts | NaBPh₄-1 Part | 10 Parts | Stable | 30 Sec |
| | MBPS- 0.1 Parts | DIDMA-1 Part | 10 Parts | 24 h | 50 Sec |
| ETMPTA- 100 Parts | MBPS- 0.1 Parts | NaBPh₄-1 Part | 10 Parts | Stable | 30 Sec |
| | MBPS- 0.1 Parts | DIDMA-1 Part | 10 Parts | 24 h | 50 Sec |
| MPEGA- 100 Parts | MBPS- 0.1 Parts | NaBPh₄-1 Part | 10 Parts | Stable | 60 Sec |
| | MBPS- 0.1 Parts | DIDMA-1 Part | 10 Parts | 24 h | 70 Sec |

* TMPTA-Trimethylolpropane triacrylate; ETMPTA-ethoxylated (20) trimethylolpropane triacrylate; MPEGA-Methoxy polyethyleneglycol (550) monoacrylate; MBPS-Methylene Blue persulfate; DIDMA-2,6-diisopropyl-N,N′-dimethylaniline; DMAA-dimethylacetamide.

### Example 1

### Preparation of a Hydrogel in Presence of Water Dispersible Acrylic Monomers

Commercially available potassium persulfate (30 mg, Sigma Aldrich) is dissolved in 0.6 gm distilled water with thorough mixing. Sodium tetraphenylborate (NaBPh₄, 30 mg) is added to the solution which turns cloudy. To the resulting cloudy mixture, 3 gm of acrylic monomer SR415 (Sartomer) is added, and mixed thoroughly until a clear solution results. In another vessel, 3 mg Methylene Blue (Sigma Aldrich) is dissolved in 0.15 gm distilled water. The resulting Methylene Blue solution is added to the clear solution containing potassium persulfate, NaBPh₄, and monomer. The solution is mixed thoroughly until a blue solution is obtained. The solution thus prepared is wrapped with aluminum foil to protect it from exposure to visible light, and is allowed to stay at room temperature (˜28° C.) to check its thermal stability. No polymerization or gelation is observed even after a week at room temperature.

The solution above (1.5 g) is placed between two glass slides separated by a TEFLON spacer of 2.4 mm thickness. The solution is then exposed to visible light, maintained 10 mm from the reflector of a projector wrapped with Kapton film (Polyimide film, DuPont, Bandpass λ>450 nm), 1.05 WCm². After irradiation, the solution of the monomer gels into a solid polymer piece. The required time for gelation in this example was 10-12 seconds.

### Example 2

### Hydrogel in Presence of Water Dispersible Acrylic Monomers

Commercially available potassium persulfate (30 mg, Sigma Aldrich) is dissolved in 0.6 gm distilled water via thorough mixing. In another vessel, 3 mg Methylene Blue (Sigma Aldrich) is dissolved in 0.15 gm distilled water. The resulting Methylene Blue solution is added to the potassium persulfate solution. The solution changes to purple color. The solution is then shaken well, and 3 gm of acrylic monomer SR415 (Sartomer U.S.A.) is added. The mixture is stirred thoroughly until homogeneity is achieved, and the color of the solution changes to blue. The donor 2,6-diisopropyl-N,N′-dimethylaniline (30 mg) is added to the blue solution, and the solution mixed thoroughly using a stirrer. The solution thus prepared is wrapped with aluminum foil to protect it from exposure to visible light, and allowed to stay at room temperature (˜28° C.) to check its thermal stability. A clear gelation, suggesting thermal polymerization, is observed after 24 h.

A fresh stock of the above formulation is prepared following the method described. 1.5 gm of the freshly prepared solution is then placed between two glass slides separated by a TEFLON spacer of 2.4 mm thickness. The solution is next exposed to visible light, maintaining a 10 mm distance from the reflector of a projector that is wrapped with KAPTON film (Polyimide film, DuPont, Bandpass ˜λ>450 nm), 1.05 WCm². After irradiation for the required time, the solution of the monomer gels into a solid polymer piece. The required time for gelation was 12-15 seconds.

### Example 3

### General Method for Preparation Hydrogels Using Water Dispersible Acrylic Monomers (Except when the Donor is NaBPh₄)

Commercially available potassium persulfate (30 mg, Sigma Aldrich) is dissolved in 0.6 gm distilled water via thorough mixing. In another vessel, 3 mg Methylene Blue (Sigma Aldrich) is dissolved in 0.15 gm distilled water. The resulting Methylene Blue solution is added to the potassium persulfate solution. The solution changes to purple color. The solution is then shaken well, and 3 gm of acrylic monomer (Sartomer U.S.A.) is added. The mixture is stirred thoroughly until homogeneity is achieved, and the color of the solution changes to blue. Donor (30 mg) is added directly to the blue solution, if it is a liquid. Otherwise, the donor (30 mg) is dissolved in 0.3 gm 1-methoxy-2-propanol prior to adding it to the blue solution. The mixture is mixed thoroughly using a stirrer upon addition of the donor. The solution thus prepared is wrapped with aluminum foil to protect it from exposure to visible light; and is allowed to stay at room temperature (˜28° C.) to check its thermal stability. While most of the donors showed no sign of polymerization or gelation, amine donors containing at least one α-H start gelling at room temperature (refer Table 2).

Fresh stocks of the respective formulations are prepared according to the method described above. Freshly prepared solution (1.5 g) is then placed between two glass slides separated by a Teflon spacer of 2.4 mm thickness. The solution is then exposed to visible light, maintaining 10 mm from the reflector of a projector where the reflector is wrapped with Kapton film (Polyimide film, available from DuPont, Bandpass ˜λ>450 nm), 1.05 WCm². Upon irradiation, the solution of the photoactive system turns into a solid polymer piece. The required time for gelation depends on the type of the donor and the monomer used and is measured.

### Example 4

### Preparation of Emulsion Polymers Using NaBPh₄

Commercially available potassium persulfate (30 mg) is dissolved in 0.6 gm distilled water via thorough mixing. Sodium tetraphenylborate (NaBPh₄, 30 mg) is added to the solution. To the resulting cloudy mixture, 3 gm of trimethylolpropane triacrylate (TMPTA, Sartomer) is added, and mixed vigorously in a Hauschild speedmixer until an emulsion is obtained. In another vessel, 3 mg Methylene Blue is dissolved in 0.15 gm distilled water. The resulting solution is added to a clear solution containing potassium persulfate, NaBPh₄, and TMPTA. The result is mixed thoroughly, and a blue solution is obtained. The solution thus prepared is wrapped with aluminum foil to protect it from exposure to visible light; and allowed to stay at room temperature (˜28° C.) to check its thermal stability. No polymerization or gelation is observed even after a week at room temperature.

The solution prepared according to the above description (1.5 g), is placed between two glass slides separated by a Teflon spacer of 2.4 mm thickness and exposed to visible light while maintaining a 10 mm distance from the reflector of a projector wrapped with Kapton film (Polyimide film, DuPont, Bandpass ˜λ>450 nm), 1.05 WCm². After irradiation for 30 sec, the monomer gels into a solid polymer piece.

### Example 5

### Preparation of Emulsion Polymers Using Surfactants, Both in Presence of NaBPh₄ and Other Donors

Commercially available potassium persulfate 30 mg is dissolved in 0.6 gm distilled water via thorough mixing. Sodium tetraphenylborate (NaBPh₄, 30 mg) is added to the solution. The solution turns cloudy. If the donor is something other than NaBPh₄, it can also added (30 mg) at this stage-directly if it is obtained as a liquid, or as a solution in 0.3 gm 1-methoxy-2-propanol if it is a solid. The mixture separates in two phases at this stage. To a mixture comprised of potassium persulfate and a donor, is added sorbitan monolaurate (0.9 gm, as SPAN®20 available for Sigma Aldrich). The combination is then mixed vigorously in a Hauschild speed mixer to obtain a cloudy emulsion. To the resulting cloudy mixture, 3 gm of trimethylolpropane triacrylate (TMPTA) is added, and the mixture stirred again vigorously in a Hauschild speedmixer. In another vessel, 3 mg Methylene Blue is dissolved in 0.15 gm distilled water. The resulting Methylene Blue solution is added to the clear solution containing potassium persulfate, NaBPh₄, and TMPTA. The solution is further mixed thoroughly providing a blue solution. The solution thus prepared is wrapped with aluminum foil to protect it from exposure to visible light; and is allowed to stay at room temperature (˜28° C.) to check its thermal stability. The thermal stability varies for other donors. No polymerization or gelation is observed even after a week at room temperature, if the donor is NaBPh₄.

Freshly prepared solution (1.5 g) according to the above description, is placed between two glass slides separated by a Teflon spacer of 2.4 mm thickness and exposed to visible light maintained 10 mm from the reflector of a projector; where the reflector of the projector is wrapped with Kapton film (Polyimide film, DuPont, Bandpass ˜λ>450 nm (1.05 WCm².), After exposure for 40 sec (when the donor is NaBPh₄), the solution of monomer gels into a solid polymer piece. The time required for the gelation, in case of other donors than NaBPh₄, depends on the type of donor used The results are shown in Table 3.

### Example 6

### Synthesis of Methylene Blue Persulfate (MBPS)

Structure of Methylene Blue persulfate:

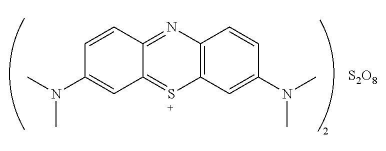

Chemical Formula: C₃₂H₃₆N₆S₄O₈: Molecular weight: 760

### Color: Purple; Texture: Powder

IUPAC Name: 3,7-bis(dimethylamino)-phenothiazin-5-ium persulfate
Common Name: Methylthioninium persulfate (Methylene Blue persulfate; MB-PS)

All reactions were carried out using deionized (DI) water. The chemicals were used as received (Sigma Aldrich). To an aqueous solution of Methylene Blue chloride salt (650 mg; 2 mmol) in 500 mL, aqueous solution of potassium persulfate (350 mg; 1.3 mmol; in 100 mL water) was added. The mixture was shaken vigorously to ensure complete reaction. A purple precipitate begins to form almost immediately. The mixture is then stirred for 30 min until complete precipitation. The precipitate is then filtered through Buckner funnel; washed several times with water to remove unreacted Methylene Blue (if any) and excess potassium persulfate. The precipitate is then dried under vacuum until dry purple powder is obtained. The precipitate thus obtained is used for polymerization reactions without further treatment.

Characterization:

1. Elemental Analysis: Molecular weight: 760: C₃₂H₃₆N₆S₄O₈

Theoretical: C- 50.53%; H- 4.73%; N- 11.05%; S- 16.84%; O- 16.84%.

Found: C- 49.37% and 49.25% (avg. 49.31%); H- 4.83% and 4.85% (avg. 4.84%); N- 11.02% and 10.91% (avg. 10.97%); S- 16.72% and 16.57% (avg. 16.65%).

### Example 7

### Polymerization Procedure

To a solution of MBPS (10 mg) in dimethylacetamide (DMAA) 1 g, 0.1 g of sodium tetraphenylborate (NaBPh₄) was added. Sodium tetraphenylborate provides the donor anion, BPh₄⁻. The mixture was stirred sufficiently to completely dissolve NaBPh₄. To the resulting solution TMPTA (10 g) was added. The mixture is then mixed thoroughly using a Haus-Child speed mixture to obtain a purple solution. The solution thus prepared is stored in dark at room temperature (˜28° C.). No polymerization or gelation was observed in the dark for weeks at room temperature.

For photo-polymerization, the solution above (1.5 g) is placed between two glass slides separated by a Teflon spacer of 2.4 mm thickness. The solution is then exposed to visible light, maintained 10 mm from the reflector of a projector wrapped with Kapton film (bandpass ˜λ>450 nm), 1.05 WCm-2. After irradiation, the solution of the monomer gels into a solid polymer piece. The required time for gelation in this example was 30 s.

From the above work it can be concluded that most of cationic dye/persulfate anion systems are thermally stable. Anionic dye/persulfate systems can be, though they are not necessarily, unstable. For example, cyanine dye S0523. where the electron rich SO₃⁻ group in S0523 contributes via a redox reaction process. (J. Polym. Sci. Part A1964, 2, 4441). Dye/persulfate anion systems can initiate photo-polymerization with the speed of polymerization being slightly faster in case of anionic dyes and dyes containing electron rich groups. Persulfate/amine systems can function as a redox couple and initiate polymerization. Persulfate/donor systems other than those with amines (include borates and cyclic nitrogen containing structures) do not initiate thermal polymerization reactions. Persulfate/donor systems in the presence of suitable light absorbers can initiate photo-polymerization. The presence of persulfate increases the rate of such reactions for photo-polymerization significantly. There is no polymerization after 30 min irradiation for Methylene Blue/DIDMA or Methylene Blue/Pyridine systems in absence of persulfate anion.

While the invention has been described with reference to certain exemplary embodiments thereof, those skilled in the art may make various modifications to the described embodiments of the invention without departing from the scope of the invention. The terms and descriptions used herein are set forth by way of illustration only and not meant as limitations. In particular, although the present invention has been described by way of examples, those skilled in the art will recognize that these and other variations and modifications are possible within the scope of the invention as defined in the following claims and their equivalents.

What is claimed is:

1. A photosensitive composition comprising:
a light absorber;
an electron transfer donor or acceptor; and
a composition containing a persulfate.

2. The composition of claim 1 wherein the electron transfer donor is oxidized by the excited state of the light absorber.

3. The composition of claim 1 wherein the electron transfer acceptor is reduced by the excited state of the light absorber.

4. The composition of claim 1 wherein the persulfate is represented by the formula Xᵢ persulfate, wherein Xᵢ is a metal or an organic cation or cationic dye, and i is 1 when the valence of X is 2 and i is 2 when the valence of X is 1.

5. The composition of claim 4 wherein X is a metal cation.

6. The composition of claim 5 wherein the metal cation is selected from the group of Na, K, Li, Cs, and Ru cations.

7. The composition of claim 4 wherein X is an organic cation selected from the group of NR₄⁺ and PR₄⁺ where R is an alkyl group or an aryl group and the R's in a cation can be the same or different.

8. The composition of claim 4 wherein X is a cationic dye.

9. The composition of claim 7 wherein the cation is selected from the group of SR₃⁺, OR₃⁺ and IR₂⁺ where R is an alkyl group or an aryl group and the R's in a cation can be the same or different.

10. A photosensitive composition comprising:
a salt of a cationic dye and a persulfate; and
an electron transfer donor.

11. The composition of claim 10 wherein the salt is Methylene Blue persulfate.

12. The composition of claim 10 wherein the cationic dye is a cyanine dye.

13. A photosensitive composition comprising:
a light absorbing hydrogen atom abstractor
a hydrogen atom donor
and a composition containing a persulfate.

14. The composition of claim 13 wherein the excited state of the light absorber, abstracts a hydrogen atom from the hydrogen atom donor, hydrogen atom donor.

15. The composition of claim 13 in wherein the persulfate is represented by the formula Xᵢ persulfate, wherein Xᵢ is a metal or an organic cation or cationic dye, and i is 1 when the valence of X is 2 and i is 2 when the valence of X is 1.

16. The composition of claim 15 wherein X is a metal cation.

17. The composition of claim 16 wherein the metal cation is selected from the group of Na, K, Li, Cs, and Ru cations.

18. The composition of claim 15 wherein X is an organic cation selected from the group of NR₄⁺ and PR₄⁺ where R is an alkyl group or an aryl group and the R's in a cation can be the same or different.

19. The composition of claim 14 wherein the light absorber is a ketone and the hydrogen atom donor is an alcohol.

20. The composition of claim 19 wherein the light absorber is a water soluble benzophenone and the hydrogen atom donor is a methyl alcohol.

21. The composition of claim 20 wherein the light absorber is p-benzoylbenzoic acid or a salt thereof.
